(19) United States
(12) Patent Application Publication
(10) Pub. No.: US 2011/0001700 A1
(43) Pub. Date: Jan. 6, 2011

(54) Online Video and Web Browser remote control

(75) Inventor: Ruda Yoav, Tel-Aviv (IL)

Correspondence Address: Yoav Ruda, Vizel 7, Tel-Aviv, 64241, omitted

(73) Assignee: Yoav Ruda, Tel-Aviv (IL)

(21) Appl. No.: 12/825,622

(22) Filed: Jun. 29, 2010

Related U.S. Application Data
(60) Provisional application No. 61/222,124, filed on Jul. 1, 2009.

(51) Int. Cl. G06F 3/033

(52) U.S. Cl. 345/157

(57) ABSTRACT

This invention refers to an online video and web browser remote control specifically; this invention refers to an online video and web browser remote control, which enables command and control of online media at the touch of a button and providing much the same experience as when watching television, without using either a mouse or a keyboard.

### FIELD OF THE INVENTION

This invention refers to an online video and web browser remote control. Specifically, this invention refers to an online video and web browser remote control, which enables command and control of online media at the touch of a button and providing much the same experience as when watching television, without using either a mouse or a keyboard.

### BACKGROUND OF THE INVENTION

Most of the existing command and control Solutions for online media and surfing using a browser require the use of a mouse and keyboard, the use of which is less than convenient, when sitting comfortably in an armchair to view the video content on screen. Today, there are a number of available control solutions, which do not require the use of a mouse, but they are still based on routing using just a cursor.

The purpose of this invention is to enable wireless control of online media using buttons on a remote control unit, which replace control using the cursor and the need to press onscreen buttons.

### SUMMARY OF THE INVENTION

This invention refers to an online video and web browser remote control, which enables wireless control of online media, using buttons on the remote control unit.

In principle, this invention is based on both hardware and software. The hardware comprises:

A. Remote control unit

B. Receiver with a USB connection

The software comprises:

A. Addition to the browser, which in accordance with this invention shall be able to identify and control media players on a web page using, for example, STOP, PAUSE, PLAY and other buttons.

B. Control of any specific function in the operating system, such as: Volume, and interfacing with the software installed on the computers, for instance—Media Player or iTunes.

In accordance with this invention, the existing NEXT buttons will load into the media player, the next clip under the category RELATIVE VIDEO on the page. The CHANNEL UP and CHANNEL DOWN buttons will toggle between the various categories available on the site and will automatically load the first video clip in each category's list. For example: Toggling between categories such as Sport, Comedy, Animations, etc.

In accordance with this invention, when a video clip or media item ends, the next item will be loaded automatically.

In accordance with this invention, the link between the remote control unit and the receiving unit shall be a wireless, optical connection, using for example, infrared or an RF transmission method.

In accordance with this invention, the remote control unit shall be divided up into four segments.

1. Browser control buttons

2. Touch pad enabling control of the cursor and scroll wheel performing scroll and zoom tasks.

3. Channel number buttons, used as shortcuts to sites.

4. Media player control buttons.

In accordance with this invention, the remote control unit shall be able to control different types of online media player, such as: Video, MP3, online radio, slide show, etc.

In accordance with one preferred configuration for the online video and web browser remote control, as described in this invention; if a web page offers a range of different media players, the default option shall be control of the first media player on the page. If the user operates one of the other media players with the help of the cursor, control will pass to that media player.

In accordance with this invention, the receiving unit can also be built into one of the computer's components, such as the computer, the screen, etc.

In accordance with this invention, the remote control unit can also have a touch pad screen, which shall include all the functions of the remote control unit using buttons to be pressed. Pressing a virtual button on the touch screen shall enable control of the online media and the browser.

In accordance with this invention, the remote control unit shall enable surfing between web sites and web pages at the press of a single button.

In accordance with this invention, the NEXT buttons shall load the item/post/next page from the original menu. For example, a posting has been selected from the main page of a specific blog. Pressing the NEXT button will load the next posting, without any need to go back to the main page. This methodology will save the user the time it takes to press on and load the page containing the original menu.

In accordance with this invention, the remote control unit shall also be able to contain other standard buttons on a universal remote control and a media remote control, enabling control of online media and the browser, available in other instruments and in the media center.

In accordance with this invention, the control of Web pages may also be accomplished with the help of directional pad remote controls (d-pad, up-down-left-right-OK buttons).

In accordance with this invention, the control of the online media player will be made by either accessing the Web page's code, or by an API/SDK (for optimized sites), or by analyzing the page and identifying the onscreen buttons.

In accordance with this invention, when there's neither access to the media player from the page's source, nor through API/SDK, the remote control software will analyze the page elements and image, and will identify the hot spots and onscreen buttons. In that scenario, when a user clicks the media button on the remote control, the cursor will automatically move over the relevant onscreen button, and will automatically click it.

### BRIEF DESCRIPTION OF THE INVENTION

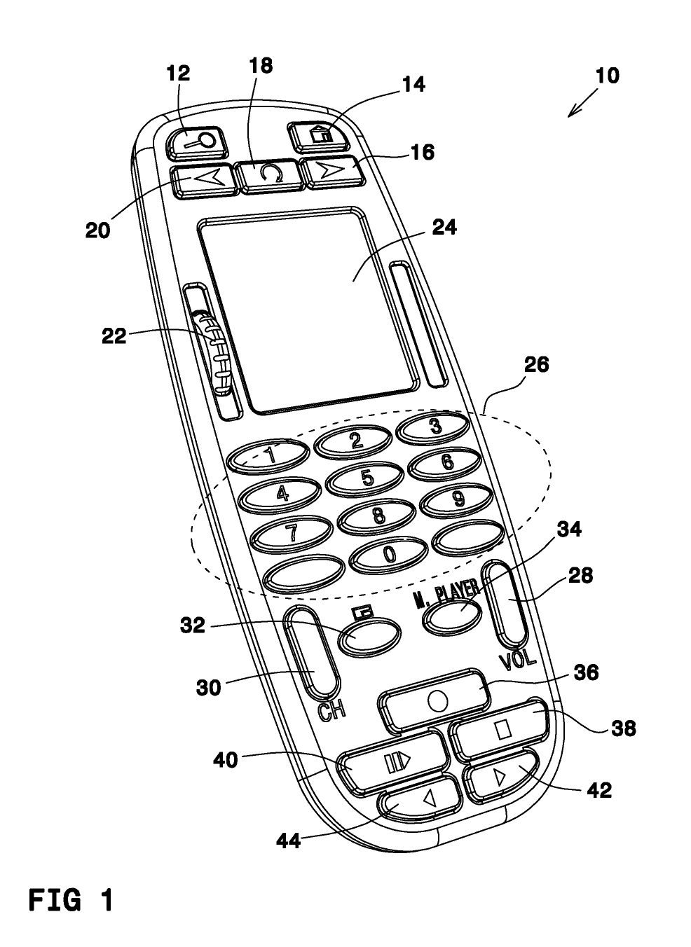

This invention shall be described in detail in FIGS. 1 to 3. These figures are designed to illustrate a number of preferred configurations for this invention, but they are not intended to limit the range of possible configurations.

The present invention may be better understood in conjunction with the following figures:

FIG. 1 is an isometric diagram illustrating the online video and web browser remote control in accordance with this invention.

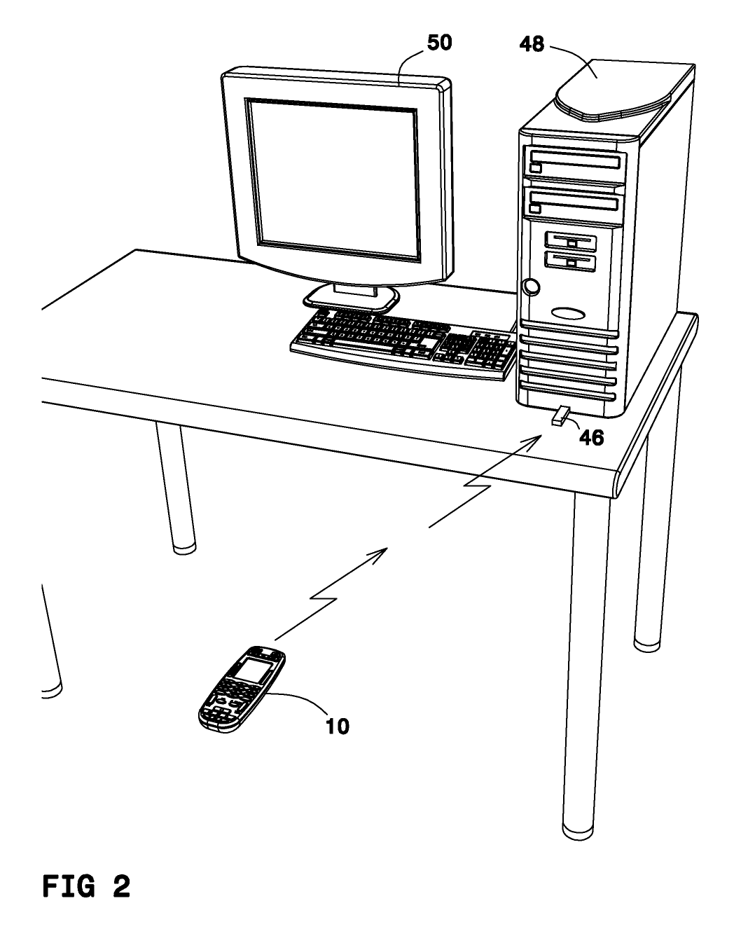

FIG. 2 illustrates control of video functions using the online video and web browser remote control through a computer connected to the internet and viewing on the computer screen in accordance with this invention.

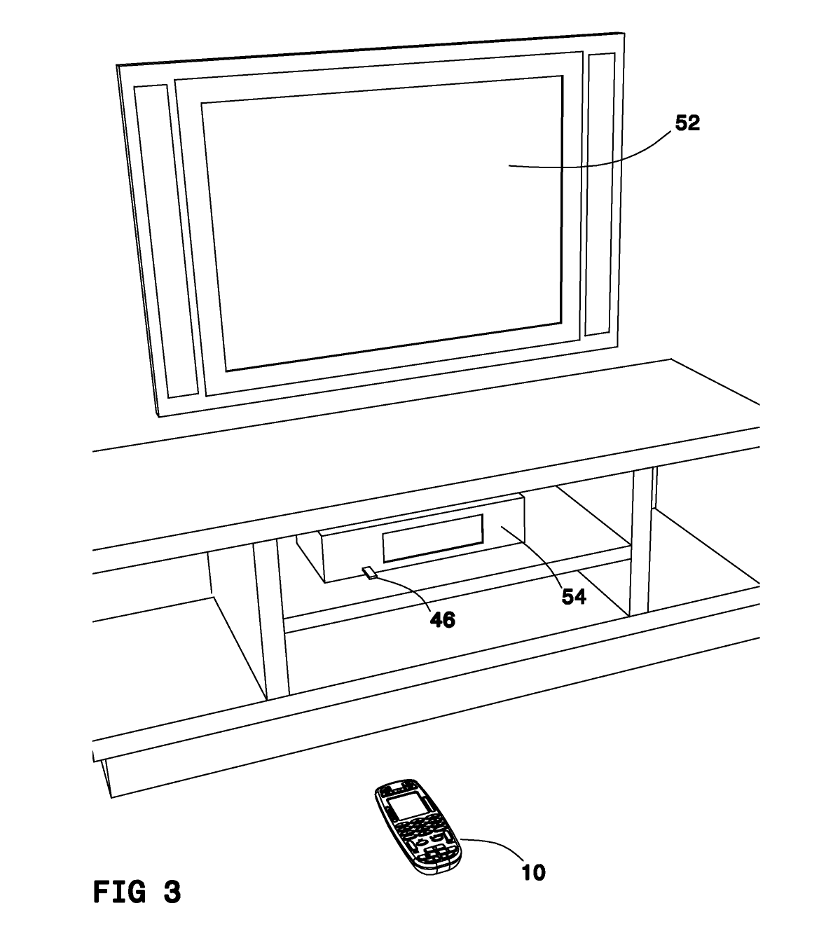

FIG. 3 illustrates control of video functions using the online video and web browser Remote control through a media center system or a personal computer connected to the internet and viewing on a television screen in accordance with this invention.

### DETAILED DESCRIPTION OF THE ILLUSTRATIONS

FIG. 1 is an isometric diagram illustrating the online video and web browser remote control (10) in accordance with this invention.

The remote control unit (10) is divided up into four segments. The uppermost segment on the remote control unit is the segment designated for the control of the web browser and it comprises the following buttons; Browser open and close (56); shortcut to home page button (14); shortcut to internet search button (12); browser forward and back buttons (16, 20) and a refresh button (18).

The second segment on the remote control unit (10) is designated for the replacement of computer mouse functions and this segment comprises a touch pad (24) for the movement of the cursor.

Pressing the touch pad once or more replaces the functions of the mouse buttons. This segment also contains the scroll wheel, which controls the browser scroll bar and the zoom in and out functions.

The third segment on the remote control unit (10) comprises a keyboard (26). The keyboard keys are used to create shortcuts to internet sites (pre-programmed).

The fourth, lowest segment on the remote control unit is the media control segment, used to control online media content.

Pressing the shortcut button (34) will open the media player and to change screen configuration, the regular mode/full screen mode (32) is pressed. When the media player is open, it can be controlled using the buttons PLAY and PAUSE

(40). to stop the video clip, the STOP (38) button is pressed.

When a video clip ends, the browser buttons (42, 44) can be used to surf to clips with similar content.

The media segment also contains VOLUME UP and VOLUME DOWN (28) buttons and CHANNEL UP and CHANNEL DOWN (30) buttons.

FIG. 2 illustrates control of video functions using the online video and web browser remote control through a computer in accordance with this invention.

The online video and web browser remote control (10) transmits a wireless signal to the wireless receiver (46). The receiver (46) is connected to a USB socket in the computer and links between the remote control unit (10), the computer (48) and the media clips displayed on the computer screen (50).

FIG. 3 illustrates control of video functions using the online video and web browser remote control through a media center system or a personal computer connected to the interned and viewing on a television screen in accordance with this invention.

The remote control unit (10) transmits to the receiver (46), which is connected to the media center (54). The media center displays the media clip on the television screen (52).

While certain features of the invention have been illustrated and described herein, the invention can be embodied in other forms, ways, modifications, substitutions, changes, equivalents, and so forth. The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is

1) The online video and web browser remote control comprises:
a) Remote control unit
b) Receiver
c) Software
Together, these components enable wireless control of the online media in web pages, using actual buttons on the remote control unit or virtual buttons on a remote control unit with a touch pad. The remote control buttons replace the need to control using a cursor and pressing onscreen buttons provided by the web page.

2) Browser software or an addition to the browser shall interface with the existing remote control unit (personal computer remote control, media center or other remote control), enabling wireless control of online media in web pages using either the actual buttons on the remote control unit or the virtual buttons on a remote control unit with a touch pad. The remote control buttons replace the need to control using a cursor and pressing onscreen buttons provided by the web page.

3) Browser software or an addition to the browser shall enable toggling to the next item on the menu (the next page), by pressing the NEXT button, without any need to go back to the menu on the previous page.

4) Browser software or an addition to the browser shall analyze Web pages, identify the hotspots and on screen buttons, automatically move the cursor over the onscreen buttons (according to presses on buttons on a remote control) and automatically click it.
